(19) United States
(12) Patent Application Publication
(10) Pub. No.: US 2019/0033820 A1
(43) Pub. Date: Jan. 31, 2019

(54) NUMERICAL CONTROLLER

(71) Applicant: FANUC CORPORATION, Minamitsuru-gun (JP)

(72) Inventors: Chao Zhi, Minamitsuru-gun (JP); Yuanming Xu, Minamitsuru-gun (JP)

(73) Assignee: FANUC CORPORATION, Minamitsuru-gun (JP)

(21) Appl. No.: 16/044,789

(22) Filed: Jul. 25, 2018

(30) Foreign Application Priority Data
Jul. 26, 2017 (JP) 2017-144083

(51) Int. Cl. G05B 19/404; G05B 19/4093; B23Q 11/00

(52) U.S. Cl. CPC G05B 19/404; G05B 2219/49219; B23Q 11/0007; G05B 19/4093

(57) ABSTRACT

A numerical controller which compensates an estimated value of a thermal displacement amount of a machine tool is provided with an estimation unit comprising a learning model having learned the correlations between information on the temperature of the machine tool and information on a thermal displacement and configured to acquire the information on the temperature from the machine tool and calculate an estimated value of the thermal displacement, based on the information on the temperature and the learning model, a compensation condition acquisition unit configured to acquire positioning information from the machine tool, and a compensation unit configured to compensate the estimated value of the thermal displacement based on the positioning information.

### BACKGROUND OF THE INVENTION

### Field of the Invention

The present invention relates to a numerical controller, and more particularly, to a numerical controller capable of compensating a deviation of a predicted value caused by the individual differences or aging of machine tools, in performing thermal displacement compensation for a machine tool by machine learning.

### Description of the Related Art

Thermal displacement is caused in various parts of a machine tool by heat generated as the machine tool machines a workpiece. For example, thermal displacement occurs in a spindle or a feed shaft due to heating of a spindle motor. Japanese Patent Application Laid-Open No. 06-8107 describes a numerical controller that is configured to perform machine learning by a neural network for the correlation between the temperature and thermal displacement of a machine tool, predict the thermal displacement in the machine tool during the operation by using the learning model, and compensate the operation.

In some cases, however, there may be a difference between the value of the thermal displacement predicted by the initially created learning model and an actual thermal displacement amount in the machine tool in operation, due to the individual differences or aging of machine tools. Thus, the accuracy predicted by the learning model may possibly be reduced. Conventionally, therefore, the learning model itself is updated to maintain the predicted accuracy by performing re-learning or additional learning as required.

In order to update the learning model, however, a number of man-hours and information processing resources are required to acquire temperature data and thermal displacement amounts and construct the learning model. An increase in the number of man-hours will result in a reduction in the productivity of factories. Moreover, processing for the construction of the learning model requires a lot of information processing resources, so that it is difficult for numerical controllers with low processing performance to carry out this processing.

### SUMMARY OF THE INVENTION

The present invention has been made in order to solve the above problems and its object is to provide a numerical controller capable of compensating a deviation of a predicted value caused by the individual differences or aging of machine tools, in performing thermal displacement compensation for a machine tool by machine learning.

A numerical controller according to one embodiment of the present invention is a numerical controller which compensates an estimated value of a thermal displacement amount of a machine tool and comprises an estimation unit comprising a learning model having learned the correlations between information on the temperature of the machine tool and information on a thermal displacement and configured to acquire the information on the temperature from the machine tool and calculate an estimated value of the thermal displacement, based on the information on the temperature and the learning model, a compensation condition acquisition unit configured to acquire positioning information from the machine tool, and a compensation unit configured to compensate the estimated value of the thermal displacement based on the positioning information.

In the numerical controller according to the one embodiment of the present invention, the compensation unit performs the compensation by adding to or subtracting the difference between the positioning information acquired from the machine tool and a comparison reference value of the positioning information from the estimated value of the thermal displacement.

According to the present invention, there can be provided a numerical controller capable of compensating a deviation of a predicted value caused by the individual differences or aging of machine tools, in performing thermal displacement compensation for e machine tool by machine learning.

### BRIEF DESCRIPTION OF THE DRAWINGS

The above and other objects and features of the present invention will be obvious from the ensuing description of embodiments with reference to the accompanying drawings, in which:

FIG. 1 is a block diagram showing a configuration of a numerical controller;

FIG. 2 is a diagram showing an example of a method for acquiring positioning information;

FIG. 3 is a flowchart showing the operation of the numerical controller;

FIG. 4 is a block diagram showing a configuration of an information processing apparatus;

FIG. 5 is a block diagram showing a configuration of the information processing apparatus;

FIG. 6 is a block diagram showing a configuration of the information processing apparatus;

FIG. 7A is a diagram illustrating a neuron; and

FIG. 7B is a diagram illustrating a neural network.

### DETAILED DESCRIPTION OF THE PREFERRED EMBODIMENTS

An embodiment of the present invention will be described with reference to the accompanying drawings.

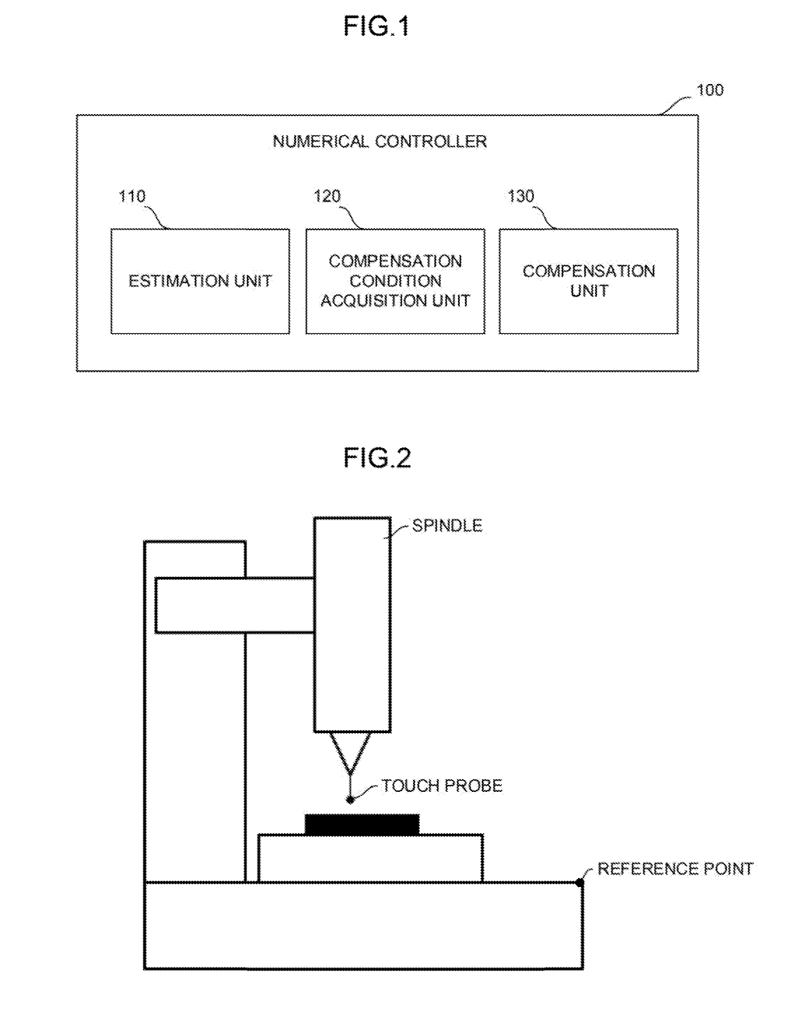

FIG. 1 is a block diagram showing a machine configuration of a numerical controller 100 according to the embodiment of the present inversion. Typically, the numerical controller 100 is a computer comprising a central processing unit (CPU), storage device, input/output device and the like. Processing units described later are logically implemented as the CPU reads out and executes programs stored in the storage device. The numerical controller 100 comprises an estimation unit 110, compensation condition acquisition unit 120, and compensation unit 130 for use as the processing units.

The estimation unit 110 estimates a thermal displacement amount based on the temperature of each part of a machine tool, using a learning model previously created by an information processing apparatus 200. The information processing apparatus 200 may be either the numerical controller 100 or an information processing apparatus outside the numerical controller 100. A method for creating the learning model by the information processing apparatus 200 will be described later. The estimation unit 110 acquires a predicted value of the thermal displacement amount based on the temperature of the machine tool by using a machine learning device 300 of the information processing apparatus 200 in an estimation mode.

The compensation condition acquisition unit 120 acquires the displacement amount of each part of the machine tool. The displacement amount acquired by the compensation condition acquisition unit 120 is not attributable to heat generated by machining but to individual differences or aging of machine tools. The compensation condition acquisition unit 120 comprises a touch probe, for example.

The touch probe contacts a predetermined positioning point on a table and outputs coordinates of the positioning point based on a machine coordinate system. The compensation condition acquisition unit 120 acquires these coordinates as compensation conditions of the thermal displacement amount estimated by the learning model.

The acquisition of the positioning point will be further described with reference to FIG. 2. The touch probe is mounted on the distal end of the spindle of the machine tool. The touch probe outputs the coordinates of a contact point to the outside. The thus output coordinates are the coordinates of the contact point as viewed from the machine coordinate system. For example, the machine tool measures a predetermined reference point on the table or the like by means of the touch probe before the start of the machining.

This measurement will be referred to as positioning, and information acquired by the positioning as positioning information. Since the coordinates acquired by the positioning are obtained before the start of the machining, they are not influenced by thermal displacement caused by the machining. On the other hand, the results of the measurement of the reference point by the positioning are represented as the coordinates viewed from the machine coordinate system, so that they can be changed under the influence of the individual differences or aging of machine tools. According to the present embodiment, the compensation condition acquisition unit 120 acquires the coordinates of the reference point measured by the positioning as information for compensating the influence of the individual differences or aging of machine tools.

The compensation unit 130 compensates the thermal displacement amount estimated by the learning model of the estimation unit 110, using the compensation conditions acquired by the compensation condition acquisition unit 120. Thus, the compensation unit 130 corrects a deviation of the predicted value caused by the individual differences or aging of machine tools.

An example of the method for creating the learning model by the information processing apparatus 200 as the background art of the present invention will now be described for easier understanding of the invention. Thereafter, the operation of the numerical controller 100 according to the present embodiment will be described more specifically.

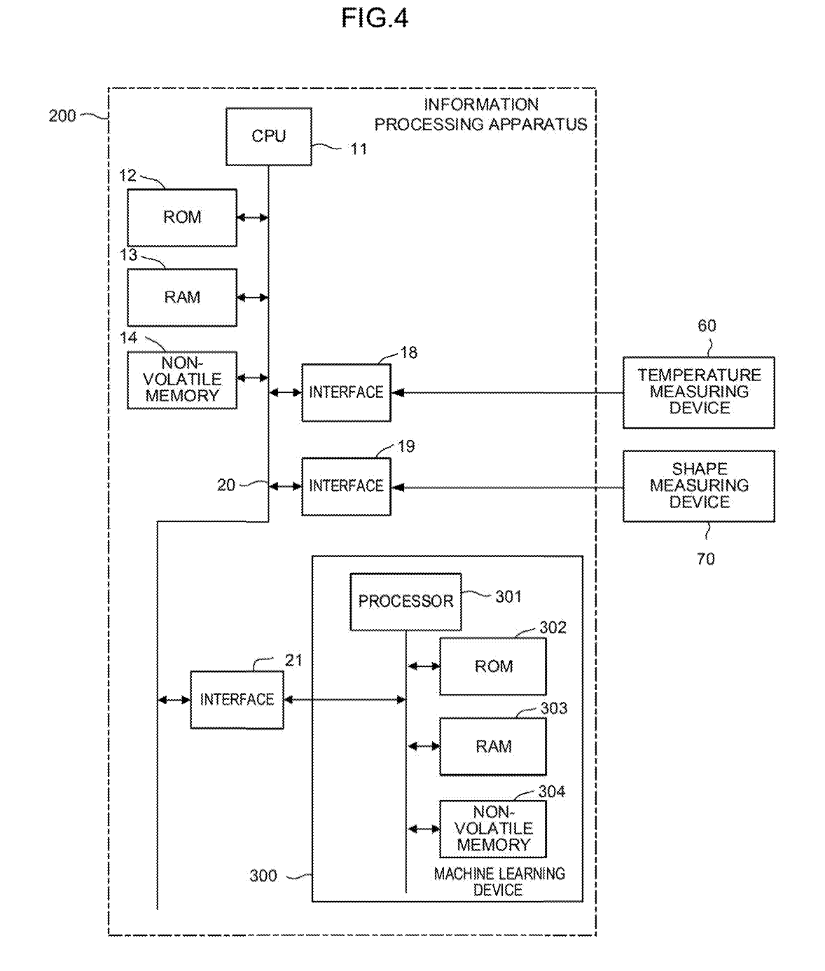

FIG. 4 is a schematic hardware configuration diagram showing principal parts of the information processing apparatus 200. A CPU 11 is a processor for generally controlling the information processing apparatus 200. The CPU 11 reads out a system program stored in a RAM 12 and controls the entire information processing apparatus 200 according to this system program. A RAM 13 is temporarily stored with temporary calculation data and display data, various externally input data, and the like.

A non-volatile memory 14 is constructed as a memory that is, for example, backed up by a battery (not shown) so that its storage state can be maintained even when the information processing apparatus 200 is turned off. The non-volatile memory 14 is stored with various programs and data input through an interface (not shown). The programs and the data stored in the non-volatile memory 14 may be expanded in the RAM 13 at the time of execution or use. Moreover, various system programs are previously written in the ROM 12.

A temperature measuring device 60 measures the temperatures of various parts of the machine tool. The temperature measuring device 60 may be, for example, a temperature sensor or a thermography. The information processing apparatus 200 receives temperature data (measured values of temperatures, output images from the thermography, etc.) from the temperature measuring device 60 through an interface 18 and delivers them to the CPU 11.

A shape measuring device 70 measures the shapes of various parts of the machine tool. The shape measuring device 70 may be, for example, a micrometer or a displacement sensor. The information processing apparatus 200 receives shape data (lengths or displacement amounts of coordinates of predetermined portions of the machine tool, etc.) from the shape measuring device 70 through an interface 19 and delivers them to the CPU 11.

An interface 21 is an interface for connecting the information processing apparatus 200 and the machine learning device 300. The machine learning device 300 comprises a processor 301 for controlling the entire machine learning device 300, a ROM 302 stored with system programs and the like, a RAM 303 for temporary storage in each step of processing related to machine learning, and a non-volatile memory 304 used to store the learning model and the like. The machine learning device 300 can observe various pieces of information (temperature data, shape data, etc.) that can be acquired by the information processing apparatus 200 through the interface 21.

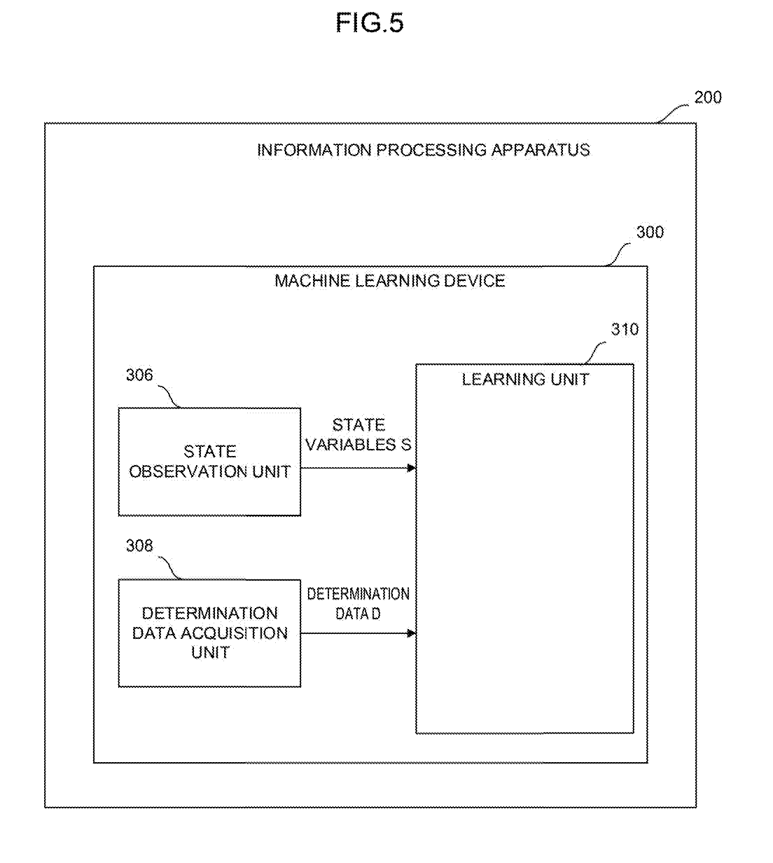

FIG. 5 is a schematic functional block diagram of the information processing apparatus 200 and the machine learning device 300.

The machine learning device 300 comprises software (learning algorithm, etc.) and hardware (processor 301, etc.) for self-learning based on the so-called machine learning of the shape data on various parts of the machine tool corresponding to the temperature data thereon. An object learned by the machine learning device 300 of the information processing apparatus 200 is equivalent to a model structure representative of the correlations between the temperature data and the shape data.

As indicated by blocks in FIG. 5, the machine learning device 300 of the information processing apparatus 200 comprises a state observation unit 306 configured to observe the temperature data as state variables S representative of the present states of the environments, a determination data acquisition unit 308 configured to acquire the shape data as determination data D, and a learning unit 310 configured to learn the temperature data in association with the shape data using the state variables S and the determination data D.

The state observation unit 306 can be constructed, for example, as a function of the processor 301. Alternatively, the state observation unit 306 can be constructed, for example, as software stored in the ROM 302 and configured to make the processor 301 function. The state variables S or the temperature data observed by the state observation unit 306 can be acquired as those output from the temperature measuring device 60. Typically, the temperature measuring device 60 is a thermography. The thermography may be configured to output image data picked up from a predetermined direction or to output a set of image data picked up from multiple directions using a robot or the like. Alternatively, the temperature measuring device 60 may be a contact or non-contact type thermometer or the like.

The determination data acquisition unit 308 can be constructed, for example, as a function of the processor 301. Alternatively, the determination data acquisition unit 308 can be constructed, for example, as software stored in the ROM 302 and configured to make the processor 301 function. The determination data D or the shape data acquired by the determination data acquisition unit 308 can be acquired as those output from the shape measuring device 70. Typically, the shape measuring device 70 is a micrometer. The micrometer is set on each part of the machine tool and outputs a measured value (length) every time machining is performed, for example.

The learning unit 310 can be constructed, for example, as a function of the processor 301. Alternatively, the processor 301 can be constructed, for example, as software stored in the ROM 302 and configured to make the processor 301 function. The learning unit 310 learns the relationships between the temperature data and the shape data according to an arbitrary learning algorithm collectively called the machine learning. The learning unit 310 can repeatedly perform learning based on a data set including the above state variables S and the determination data D.

By repeating those learning cycles, the learning unit 310 can automatically identify characteristics suggestive of the correlations between the temperature data and the shape data. Although the correlations between the temperature data and the shape data are practically unknown at the start of the learning algorithm, the learning unit 310 interprets the correlations by gradually identifying the characteristics with the progress of the learning. If the correlations between the temperature data and the shape data are interpreted to some reliable level, the learning results repeatedly output by the learning unit 310 can be used to estimate a desirable form of the shape data based on the present state (temperature data). Thus, the learning unit 310 can gradually approximate the correlations between the temperature data and the shape data to an optimal solution with the progress of the learning algorithm.

As described above, the machine learning device 300 of the information processing apparatus 200 is configured so that the learning unit 310 learns the shape data according to the machine learning algorithm, using the state variables S observed by the state observation unit 306 and the determination data D acquired by the determination data acquisition unit 308. The state variables S are composed of data that are not easily influenced by disturbances, while the label data L are obtained uniquely. Thus, according to the machine learning device 300 of the information processing apparatus 200, the shape data corresponding to the temperature data can be obtained automatically and accurately without performing calculations or estimation.

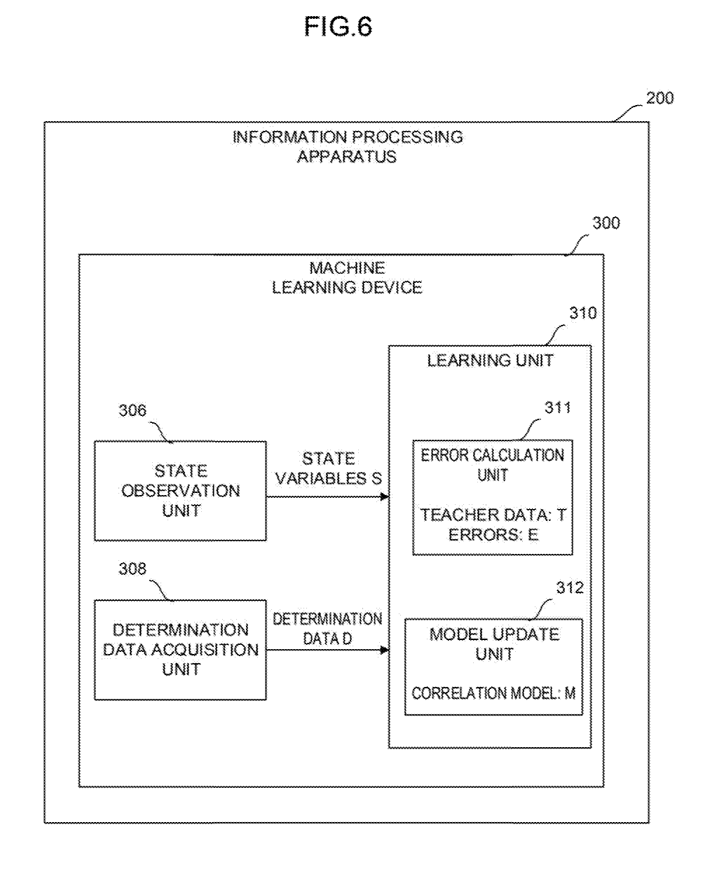

In the machine learning device 300 having the above configuration, the learning algorithm executed by the learning unit 310 is not particularly limited and a conventional learning algorithm can be used as the machine learning. FIG. 6 shows a configuration based on a form of the information processing apparatus 200 shown in FIG. 5, in which the learning unit 310 performs supervised learning as an example of the learning algorithm. The supervised learning is a method in which a large volume of known data sets (called teacher data) including inputs and outputs corresponding thereto are given in advance, and characteristics suggestive of the correlations between the inputs and the outputs are identified from these teacher data, whereby a correlation model for estimating an output (shape data corresponding to the temperature data) required for a new input is learned.

In the machine learning device 300 of the information processing apparatus 200 shown in FIG. 6, the learning unit 310 comprises an error calculation unit 311 and a model update unit 312. The error calculation unit 311 calculates errors E between a correlation model M that derives the shape data from the state variables S and correlation characteristics identified from teacher data T prepared in advance. The model update unit 312 updates the correlation model M so as to reduce the errors E. The learning unit 310 learns the correlations between the temperature data and the shape data as the model update unit 312 repeats the update of the correlation model M.

The correlation model M can be constructed by regression analysis, reinforcement learning, deep learning or the like. An initial value of the correlation model M is given, for example, as a simplified representation of the correlations between the state variables S and the shape data, to the learning unit 310 before the start of the supervised learning. For example, the teacher data T can be composed of experience values (known data sets including the temperature data and the shape data) stored as the correspondence between the past temperature and shape data are recorded, and are given to the learning unit 310 before the start of the supervised learning. The error calculation unit 311 identifies the correlation characteristics suggestive of the correlations between the temperature data and the shape data from the large volume of teacher data T given to the learning unit 310, and obtains the errors E between the correlation characteristics and the correlation model M corresponding to the state variables S in the present states. The model update unit 312 updates the correlation model M so as to reduce the errors E according to a predetermined update rule, for example.

In the next learning cycle, the error calculation unit 311 obtains the errors E with respect to the correlation model M corresponding to the state variables S and the determination data D, using the state variables S and the determination data D obtained by performing a machining stroke and an inspection stroke according to the updated correlation model M, and the model update unit 312 updates the correlation model M again. In this way, the correlation between the present states (temperature data) of the environments having so far been unknown and the states (shape data) corresponding thereto gradually becomes clear. In other words, the relationships between the temperature data and the shape data are gradually approximated to an optimal solution by updating the correlation model M.

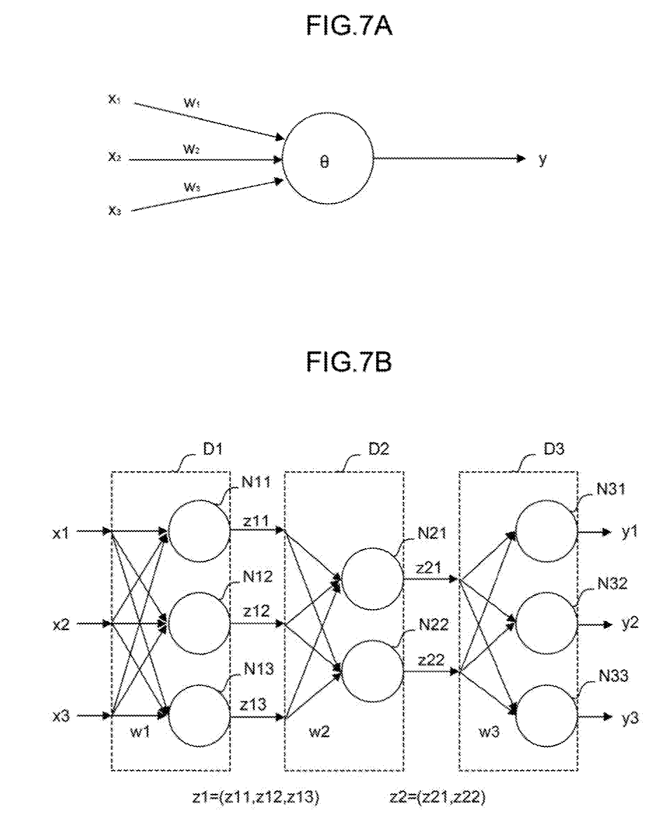

For example, a neural network can be used to advance the above supervised learning. FIG. 7A schematically shows a model of a neuron. FIG. 7B schematically shows a model of a three-layer neural network constructed by combining the neurons shown in FIG. 7A. The neural network can be composed of, for example, an arithmetic unit or a storage device imitating the neuron model.

The neuron shown in FIG. 7A outputs results y from a plurality of inputs x (e.g., inputs x₁ to x₃). The inputs x₁ to x₃ are multiplied by their corresponding weights w (w₁ to w₃). Thus, the neuron delivers the outputs y represented by Equation 1 below. In Equation 1, the inputs x, outputs y, and weights w are all vectors. Moreover, θ is a bias and fₖ is an activation function.

y=fₖ(Σᵢ₌₁ⁿxᵢwᵢ−θ)

In the three-layer neural network shown in FIG. 7B, a plurality of inputs x (e.g., inputs x1 to x3) are input from the left side and results y (e.g., results y1 to y3) are output from the right side. In the illustrated example, the individual inputs x2, x2 and x3 are multiplied by their corresponding weights (collectively represented by w1) and each of them is input to three neurons N11, N12 and N13.

In FIG. 7B, the respective outputs of the neurons N11 to N13 are collectively represented by z1. The outputs z1 can be regarded as feature vectors based on the extraction of the feature quantity of input vectors. In the illustrated example, the individual feature vectors z1 are multiplied by their corresponding weights (collectively represented by w2) and each of them is input to two neurons N21 and N22. The feature vectors z1 represent features between the weights w1 and w2.

In FIG. 7B, the respective outputs of the neurons N21 and N22 are collectively represented by z2. The outputs z2 can be regarded as feature vectors based on the extraction of the feature quantity of the feature vectors z1. In the illustrated example, the individual feature vectors z2 are multiplied by their corresponding weights (collectively represented by w3) and each of them is input to three neurons N31, N32 and N33. The feature vectors z2 represent features between the weights w2 and w3. Finally, the neurons N31 to N33 output the results y1 to y3, respectively.

In the machine learning device 300 of the information processing apparatus 200, the shape data can be output as estimated values (results y) as the learning unit 310 performs a calculation of a multi-layer structure based on the above neural network with the state variables S used as the inputs x. Operation modes of the neural network include a learning mode and a determination mode. For example, the weights w can be learned using a learning data set in the learning mode, while the shape data can be determined in the determination mode using the learned weights w. Detection, classification, inference and the like can also be performed in the determination mode.

Thus, according to the learning model created by the information processing apparatus 200, highly reliable shape data, that is, predicted values of thermal displacement amounts, can be obtained. On the other hand, generation of the learning model by the information processing apparatus 200 requires a lot of information processing resources. Moreover, the acquisition of the state variables S and the determination data D requires a large number of man-hours. Conventionally, in order to overcome a reduction in predicted accuracy due to the individual differences or aging of machine tools, it is necessary to create the learning model by inputting information for identifying individuals and information on the lapse of time as the state variables S and to update the learning model by additional online learning. This requirement is not practical, however, since the creation of the learning model requires the information processing resources to be continually spared. Thereupon, the numerical controller 100 according to the embodiment of the present invention suppresses the necessary information processing resources through such an approach that the predicted value output by the initially created learning model is corrected without changing the learning model at all.

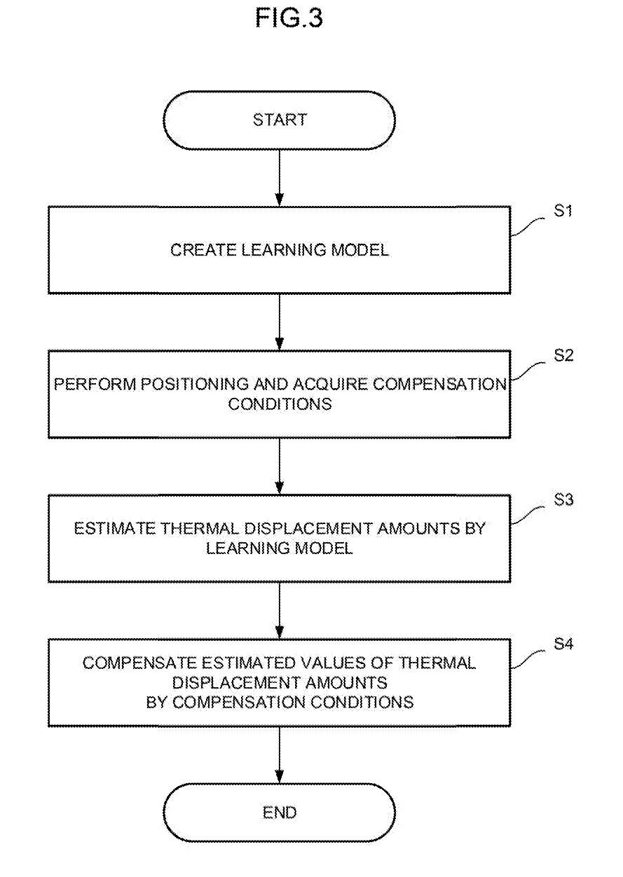

Referring then to the flowchart of FIG. 3, the operation of the numerical controller 100 according to the embodiment of the present invention will be described specifically.

S1: The information processing apparatus 200 creates the learning model indicative of the correlations between the temperature data and the shape data. For example, the information processing apparatus 200 acquires sufficient numbers of temperature data and shape data by, for example, attempting workpiece machining at the time of introduction or manufacture of the machine tool, and obtains the learning model by inputting these data as the state variables S and the determination data D to the machine learning device 300.

As this is done, the compensation condition acquisition unit 120 should perform positioning once, acquire the coordinates of the then reference point, and save them as comparison reference values of the positioning information in advance.

S2: The compensation condition acquisition unit 120 of the numerical controller 100 acquires the compensation conditions. For example, the compensation condition acquisition unit 120 performs the positioning before the start of the machining and acquires the coordinates of the reference point.

S3: The estimation unit 110 estimates the thermal displacement amounts using the learning model created by the information processing apparatus 200. In other words, the estimation unit 110 obtains the estimated values of the shape data corresponding to the temperature data using the machine learning device 300 of the information processing apparatus 200. As this is done, the machine learning device 300 is operated in the following manner.

The temperature data are input as the state variables S from the temperature measuring device 60 on each part of the machine tool to the state observation unit 306 of the machine learning device 300. The learning unit 310 of the machine learning device 300 inputs the state variables S to the learning model created in advance and outputs the estimated values of the shape data corresponding to the state variables S. The contents of these output shape data are the lengths or the displacement amounts of the coordinates of individual parts of the machine tool as a result of temperature changes.

S4: The compensation unit 130 calculates the thermal displacement amounts based on the estimated values of shape data output by the estimation unit 110 and the compensation conditions output by the compensation condition acquisition unit 120. For example, the compensation unit 130 holds the coordinates of the reference point at the time of creation of the learning model (typically, at the time of introduction or manufacture of the machine tool) as the comparison reference points, and calculates compensation amounts by calculating the differences between the coordinates of the reference point at the time of creation of the learning model and the coordinates of the reference point obtained when the positioning is performed currently (or before the start of recent machining). Then, the compensation unit 130 calculates compensated estimated values by adding to or subtracting the compensation amounts from the estimated values of the shape data output by the estimation unit 110.

According to the present embodiment, the compensation unit 130 compensates the estimated values of the thermal displacement amounts output by the estimation unit 110, using the positioning information from the compensation condition acquisition unit 120. In this way, deviations of the predicted values of the thermal displacements caused by the individual differences or aging of machine tools can be compensated easily, quickly, and accurately without requiring a large number of man-hours or information processing resources.

While an embodiment of the present invention has been described above, the invention is not limited to the above-described embodiment and may be suitably modified and embodied in various forms.

For example, in the embodiment described above, the compensation condition acquisition unit 120 uses the touch probe to acquire the compensation conditions. However, the present invention is not limited to this and various contact or non-contact type sensors (laser, optical, eddy-current, magnetic, etc.) that can measure displacements caused by the individual differences or aging of various parts of machine tools are available.

While embodiments of the present invention have been described herein, the invention is not limited to the above embodiments and may be suitably modified and embodied in other forms.

1. A numerical controller which compensates an estimated value of a thermal displacement amount of a machine tool, comprising:
an estimation unit comprising a learning model having learned the correlations between information on the temperature of the machine tool and information on a thermal displacement and configured to acquire the information on the temperature from the machine tool and calculate an estimated value of the thermal displacement, based on the information on the temperature and the learning model;
a compensation condition acquisition unit configured to acquire positioning information from the machine tool; and
a compensation unit configured to compensate the estimated value of the thermal displacement based on the positioning information.

2. The numerical controller according to claim 1, wherein the compensation unit performs the compensation by adding to or subtracting the difference between the positioning information acquired from the machine tool and a comparison reference value of the positioning information from the estimated value of the thermal displacement.
